(19) United States
(12) Patent Application Publication
(10) Pub. No.: US 2013/0073347 A1
(43) Pub. Date: Mar. 21, 2013

(54) VEHICULAR CITATION MANAGEMENT METHOD AND SYSTEM

(71) Applicants: Albert BOGAARD, Atlanta, GA (US); Jacek SADKOWSKI, Duluth, GA (US)

(72) Inventors: Albert BOGAARD, Atlanta, GA (US); Jacek SADKOWSKI, Duluth, GA (US)

(21) Appl. No.: 13/238,897

(22) Filed: Sep. 21, 2011

(51) Int. Cl. G07B 15/00; G06Q 10/00; G06Q 40/00

(52) U.S. Cl. 705/13; 705/39; 705/1.1

(57) ABSTRACT

A method and a system capable of capturing, storing and managing information relating to vehicle citations and/or vehicle violations that occur across one or more jurisdictions, locally, nationally and even internationally. The method and system also being capable of providing timely notification of the citations and/or violations, regardless of the jurisdiction, and regardless whether the owner of the vehicle is at home to receive a citation in the mail. The method and system still further capable of maintaining a complete and comprehensive list of all citations pending and paid, and an efficient and effective means to pay any fines associated with one or more citations in a single transaction.

### FIELD OF THE INVENTION

The present invention relates to an online citation management system. More particularly, the present invention relates to an online system that is capable of automatically capturing, storing and managing citation related information, notifying the party responsible for the citations, and providing a payment platform for satisfying any fines associated with the citations.

### BACKGROUND OF THE INVENTION

Historically, local and state authorities notified a party of a violation, such as a parking violation or a moving vehicle violation, by sending the party a citation in the mail. The citation was typically in the form of a ticket or a notification that a ticket was issued. Within a certain period of time, the party would have been required to contest the ticket or satisfy (e.g., pay) any fine associated with the ticket by sending a check or money order to the local or state authority.

More recently, local and state authorities have taken advantage of communication networks, such as the Internet, and other technologies, including traffic cameras and speed sensors, to provide a more convenient means for paying fines associated with citations. If, for example, a speed camera operated by a local authority captures a vehicle traveling past the camera at a speed in excess of the legal limit, information associated with the vehicle, such as the vehicle license plate number, is captured and recorded. Typically, the local authority will then send a citation or other notification, by mail, to the registered owner of the vehicle indicating that the vehicle was involved with a speeding violation. Assuming there is a fine associated with the citation, the owner may pay the fine by sending a check or a money order to the authority that issued the citation, as has been done in the past. Alternatively, the citation or notification sent by the authority may identify a website. If the owner so chooses, the owner can access the website via the Internet, navigate to the appropriate webpage and pay the fine online. The online payment is handled in much the same way that one might purchase merchandise online, that is by providing a credit card number and some other relevant information, such as the name appearing on the credit card, expiration date of the credit card and, possibly, a security code. The local authority then receives payment from the credit card company.

Although the above-identified online payment scheme employed by some local and state authorities is, for many, more convenient than mailing a check or money order, it still suffers from a number of deficiencies and inconveniencies. For instance, the above-identified online payment scheme is not comprehensive. That is, the website that provides a payment platform covers only one jurisdiction (e.g., a particular city, state or municipality). In other words, the above-identified online payment scheme does not provide the owner of the vehicle with a single source of information that comprehensively cover citations issued across multiple jurisdictions, locally, nationally or internationally. Moreover, the above-identified online payment scheme is not capable of providing timely notification of a violation in the event the owner is away from home for an extended period of time. Further still, the above-identified scheme does not permit the owner of the vehicle to pay fines associated with multiple citations in a single transaction. Accordingly, a more convenient and comprehensive citation management method and system are desirable.

### SUMMARY OF THE INVENTION

The present invention obviates the aforementioned inconveniencies and deficiencies of conventional systems and schemes associated with the payment of citations, for example, citations relating to parking and traffic violations including, but not limited to, online payment systems and methods. The present invention achieves this through a method and a system capable of capturing, storing and managing citation information across multiple jurisdictions, locally, nationally and even internationally. The present invention is also capable of providing timely notification of citations, regardless of the jurisdiction, and regardless whether the owner of the vehicle is at home to receive the citation in the mail. In order to achieve this, the present invention takes advantage of mobile telecommunication technology to notify the owner. Further, the present invention is capable of maintaining a complete and comprehensive list of all citations pending and paid, and providing an efficient and effective means to pay any fines associated with multiple citations in a single transaction.

Thus, in accordance with one or more aspects of the present invention, the above-identified and other capabilities are achieved by a vehicle citation management method. The method comprises, among other things, receiving a signal carrying identification information corresponding to a vehicle involved with a violation and carrying citation information relating to the violation. The method also comprises determining whether the vehicle identification information in the received signal matches vehicle identification information stored in memory; and if it is determined that the vehicle identification information in the received signal matches vehicle identification information stored in memory, transmitting a signal to end user equipment based on contact information stored in memory, where the contact information corresponds to the matching vehicle identification information stored in memory, and where the transmitted signal is carrying the citation information.

Further, in accordance with one or more aspects of the present invention, the above identified and other capabilities are achieved by a method for managing violations associated with a vehicle. The method comprises, among other things, receiving a signal carrying identification information corresponding to a vehicle that was involved with a violation, and carrying information relating to the violation. The method also comprises determining whether the vehicle identification information in the received signal matches vehicle identification information stored in memory; and if it is determined that the vehicle identification information in the received signal matches vehicle identification information stored in memory, transmitting a signal to end user equipment based on contact information stored in memory, wherein the contact information corresponds to the matching vehicle identification information stored in memory, and wherein the transmitted signal is carrying information relating to the violation.

Still further, in accordance with one or more aspects of the present invention, the above identified and other capabilities are achieved by a vehicle citation management method. The method comprises, among other things, receiving a signal from each of a plurality of network devices, each signal carrying identification information for a vehicle involved with a plurality of violations and carrying citation information relating to each of the plurality of violations. The method also comprises determining, for each of the received signals, whether the vehicle identification information in the corresponding, received signal matches vehicle identification information stored in memory and, if it is determined that the vehicle identification information in the corresponding, received signal matches vehicle identification information stored in memory, transmitting a signal to end user equipment based on contact information stored in memory, where the contact information corresponds to the matching vehicle identification information stored in memory, and wherein the transmitted signal is carrying the citation information in the corresponding, received signal.

### BRIEF DESCRIPTION OF THE DRAWINGS

Several figures are provided herein to further the explanation of the present invention. More specifically:

FIG. 1 illustrates a prior art system, employed by some government authorities, that permits online payment of fines associated with violations, such as traffic and parking violations relating to a local jurisdiction (e.g., a municipality or county);

FIG. 2A illustrates a citation management system in accordance with exemplary embodiments of the present invention;

FIG. 2B illustrates a citation management system in accordance with other exemplary embodiments of the present invention;

FIG. 3 illustrates an exemplary listing of multiple citations, and related information, pertaining to one or more license plate numbers that are associated with an owner, where the owner may view the listing on end user equipment, including a mobile device, in accordance with exemplary embodiments of the present invention;

FIG. 4 is a flowchart that further illustrates the notification function described above; and

FIG. 5 is a flowchart that further illustrates the notification function with respect to reminding an owner, following a predefined event or period of time, that there remain unpaid violations.

### DETAILED DESCRIPTION

It is to be understood that both the foregoing general description and the following detailed description are exemplary. As such, the descriptions herein are not intended to limit the scope of the present invention. Instead, the scope of the present invention is governed by the scope of the appended claims.

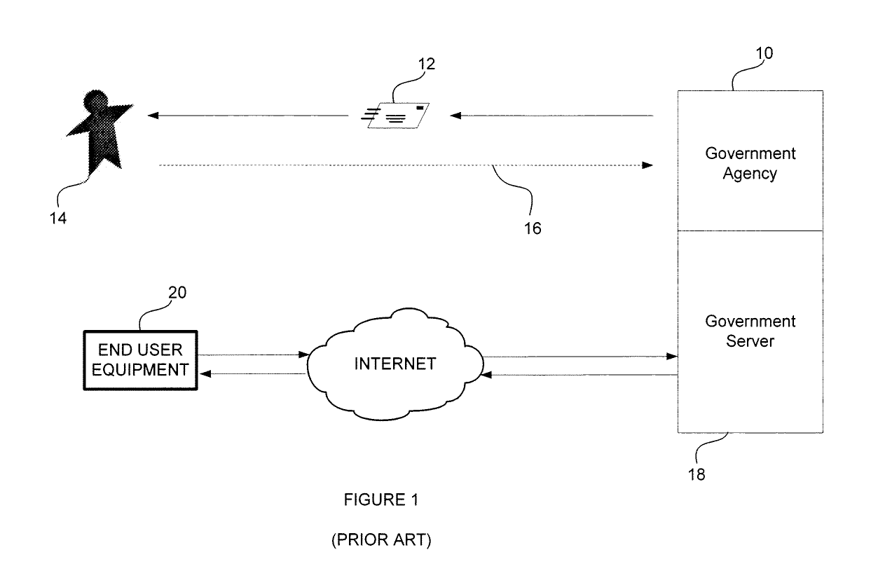

FIG. 1 illustrates a prior art system (and method), employed presently by some local and state authorities, for notifying a person of a citation relating to a parking or traffic violation, and paying any fine associated with the citation. As shown, the system is arranged such that the government agency 10, for example, may first send a paper copy of the citation 12 to the responsible person 14. The responsible person 14 can, of course, opt to pay the fine by mailing the payment back to the agency 10, as illustrated by the dashed line 16. Alternatively, the system permits the responsible person 14 to pay the fine online.

The online aspect of the system illustrated in FIG. 1 is rather simple in that it involves a server 18, associated with the government agency 10. It also would involve user equipment 20. The server 18 might host a website associated with the local or state authority. User equipment 20 would be employed by the responsible person 14 to access the website via the Internet, as shown.

The online aspect of the system illustrated in FIG. 1 may work as follows. Upon receiving, in the mail, the citation 12, the responsible person 14 may opt to go online to pay the fine associated with the citation 12. To do this, the responsible person would access the aforementioned website hosted by server 18 and navigate to the appropriate webpage for paying fines. The responsible person 14 would then go through the prescribed steps to pay the fine, for example, using a credit card in much the same way one might purchase merchandise online. Accordingly, the responsible person 14 would need to enter the credit card information into the appropriate fields on the webpage and confirm payment. The webpage would, presumably, provide a receipt for the payment and the transaction would be complete. As stated above, there are several inconveniences associated with this scheme.

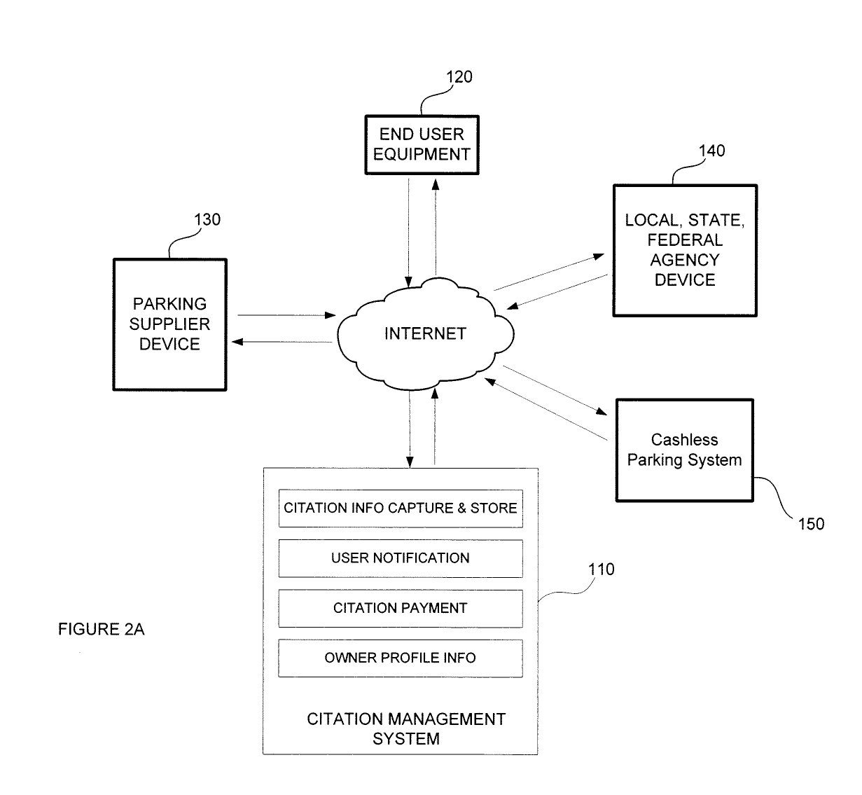

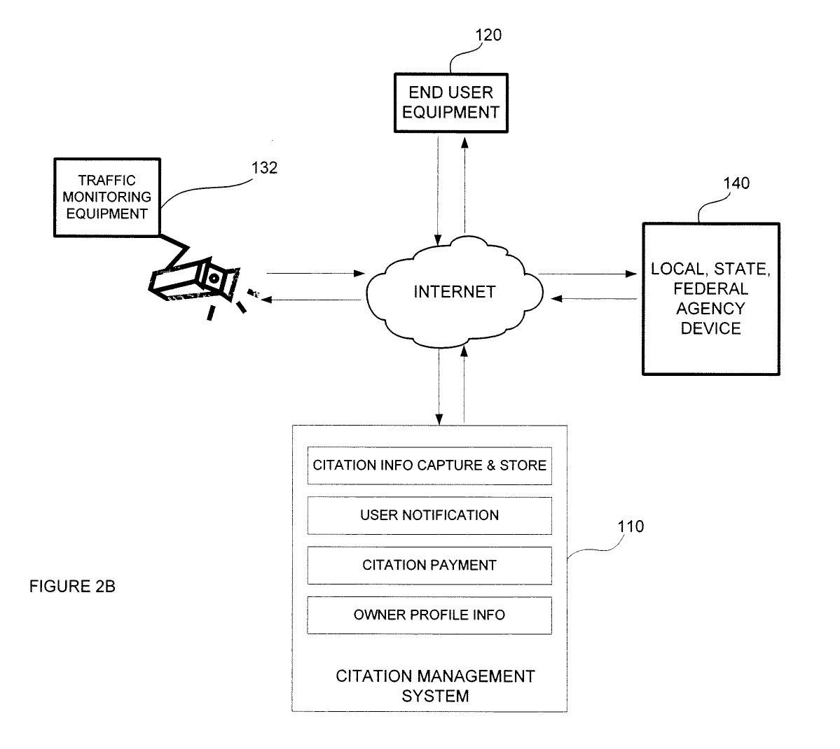

FIG. 2A illustrates a citation management system 110 in accordance with exemplary embodiments of the present invention. As stated previously, the citation management system 110 illustrated in FIG. 2A, along with the method employed there with obviates the inconveniences and deficiencies associated with the scheme illustrated in FIG. 1.

The citation management system 110, as shown, is capable of communicating with several devices via the Internet. These devices may include user equipment 120, parking supplier equipment 130 and, possibly, other devices 140, such as network servers or equipment associated with local, state, federal or international authorities. A more detailed description of these devices will be presented below.

As one skilled in the art will readily appreciate, the citation management system 110 comprises a combination of hardware, firmware and software. The general functions associated with the citation management system 110 include a citation information capture, store and management function; a user notification function, a citation payment function and a user account information management and display function. Each of these general functions are controlled by one or more programs that are structured and coded using techniques known in the art.

In accordance with one aspect of the present invention, a vehicle owner wanting to use the citation management system 110 will first establish a citation management system account. This may be achieved by accessing a website hosted by the citation management system 110. As stated above, the owner may access the website through user equipment 120 via the Internet and/or other wireless networks such as but not limited to 3G/4G and WIFI networks. The user equipment 120 may be a desk top computer, a laptop computer, a smart phone, or other mobile devices capable of accessing the website via the Internet. If one does employ user equipment 120 to set up the account, the owner would navigate to a webpage designed specifically for setting up the account. The citation management system 110, in exercising the owner profile information management function, may then prompt the owner to enter various data to establish the account. Such data is likely to include the owner's name, address, contact information, including preferential contact information, and other necessary personal information. In addition, the data needed to establish an account may include vehicle identification information for one or more vehicles. The vehicle identification information, in turn, might include for each vehicle, the make and model of the vehicle, the vehicle identification number (VIN), the current license plate number (LPN) and the state issuing the license plate. Other information may of course be needed to establish an account. Collectively, the owner data may be referred to herein as owner profile data.

Alternatively, the owner profile data might be made available through one or more other online systems. Thus, the citation management system 110 may communicate with the one or more other systems to automatically receive the owner profile data necessary to establish an account. An example of another such system the cashless parking system 150 illustrated in FIG. 2A. A detailed description of a cashless parking system is described in U.S. Provisional Application 61/446,908, entitled Parking Enforcement Method, and co-pending U.S. application Ser. No. 12/949,647, entitled Method of Processing a transaction for a Parking Session, both of which are incorporated herein by reference in their entirety.

The citation management system 110 would then create an account for the owner and store the owner profile data in memory. In a preferred embodiment, the citation management system 110 includes a database (not shown), wherein the owner profile data would be stored in appropriate fields in the database associated with the newly established account.

In addition to personal information and vehicle information, the owner profile data may include payment information. Accordingly, when setting up the account, the citation management system 110 may prompt the owner to enter information that will permit the owner to pay fines associated with any citations being managed by the citation management system 110. There are several options for effecting payment. One option would involve the use of a credit card. Thus, the owner may be prompted to enter credit card information. The credit card information would then be stored as a part of the owner profile data in a secured manner in appropriate fields of the aforementioned database. Alternatively, the owner may want to identify more than one credit card. In this case, the owner would provide the necessary credit card information for each of the two or more credit cards. Additionally, the citation management system 110 may request that the owner provide payment preference information. For example, owner payment preference information may identify one of several credit cards as a default card, which the citation management system 110 will use to effect the payment of fines unless the owner specifies otherwise. Another payment option for the owner is a stored value account, although this too would likely involve at least one credit card. In accordance with this option, the citation management system 110 would charge the owner's credit card a predefined amount in advance, and then debit that amount of money from the stored value account each time the citation management system 110 is called upon to pay a fine associated with one or more citations.

As stated above, the citation management system 110 will communicate with other devices via the Internet. Other than the user equipment 120 mentioned above, a first one of these other devices might be a device 130 associated with a parking supplier. In general, the parking supplier device 130 might be a computer-based device, fixed or mobile, wireless or wired, capable of capturing identification information for any vehicle that is parked in a location in violation of the rules governing the corresponding parking facility (e.g., a parking lot or parking space). The violation may simply be that the vehicle is parked in said location in excess of the allowed time limit.

The parking supplier device 130 may capture the vehicle identification information automatically or through a manual or partially manual process. For example, if the vehicle is parked in a location in excess of the allowed time limit, a camera may be positioned to photograph the vehicle's license plate. Alternatively, an employee at the parking facility may manually enter the vehicle identification information into the parking supplier device 130, which may be a hand-held device. The parking supplier device 130 may record the vehicle identification information along with the certain details associated with the violation; however, the parking supplier device 130 will transmit a signal via the Internet to the citation management system 110, where the signal contains encoded information that includes the vehicle identification information and the information detailing the violation (e.g., the nature of the violation, the location of the violation, time/date of the violation, and any fine or fee associated therewith). The parking facility may be a government facility, such as a parking space on a city street, or a privately owned and/or operated parking lot or garage. A full and complete description of various embodiments of the parking supplier device 130 can be found in the two aforementioned applications, U.S. Provisional Application 61/446,908 and U.S. application Ser. No. 12/949,647.

Thus, in accordance with a second aspect of the present invention, and upon receiving a signal from parking supplier device 130 that contains information including the vehicle identification information and information detailing the violation, the citation management system 110, exercising the citation capture, store and management function, will first attempt to map the information associated with the received signal to an existing account. This may be achieved, for example, by parsing the LPN from the received signal and attempting to match the LPN with those LPNs already stored in the aforementioned database.

If the citation management system 110 is unable to match the LPN in the received signal with an LPN already stored in the database, the citation management system 110 may, in accordance with one alternative embodiment, transmit a signal back to the parking supplier device 130, thus informing the entity that owns or manages the parking facility that the citation management system 110 currently maintains no existing account associated with the identified vehicle. Thereafter, the citation management system 110 may ignore or delete the information associated with the received signal, thereby leaving it to the entity that owns or manages the parking facility to notify the owner of the vehicle that a violation has occurred and that the owner must pay a fine in accordance with conventional methods, such as paying the fine by check or money order.

In another alternative embodiment, where the citation management system 110 is once again unable to match the LPN in the received signal with an LPN already stored in the data-base, the citation management system 110 may capture and store all of the information provided in the received signal, and maintain the information in a temporary account for a predefined period of time. This may be beneficial in the event the owner of the vehicle decides to open an account subsequent to the citation management system 110 receiving the signal from the parking supplier device 130. In this instance, the citation management system 110 may then proceed in managing the account as if the owner had opened the account prior to the citation management system 110 receiving the signal from the parking supplier device 130.

In accordance with a preferred embodiment, the owner has opened an account prior to the citation management system 110 receiving a signal from the parking supplier device 130. Further in accordance with the preferred embodiment, the citation management system 110 would, upon receiving the signal, parse all of the information provided in the signal, match the LPN to an LPN stored in the database and, thereafter, capture the remaining information in the signal and store the various information in corresponding data fields associated with the corresponding owner's account.

In accordance with a third aspect of the present invention, the citation management system 110, after receiving a signal from parking supplier device 130, as described above, will exercise the owner notification function and notify the owner of the vehicle that a violation has occurred. The citation management system 110 will notify the owner by any one or more of a number of means, in accordance with the owner contact information and contact preference information stored in the database. For example, depending on the contact information and contact preference information, the citation management system 100 may notify the owner by sending an email to a specified email address, a short message service (SMS) text message to a specified mobile telephone number, a multimedia message, a voice message or a combination thereof.

Alternatively, the owner may have the option to download, onto a mobile device, an application designed to communicate with the citation management system 110. In accordance with this alternative embodiment, the owner may communicate and otherwise interact with the citation management system 110 through the mobile application. The citation management system 110 may, in accordance with this embodiment, notify the owner of a violation through the mobile application.

Notifying the owner is particular useful where the owner has specified in the owner contact preference information that the citation management system 110 is to provide notification to a mobile device. That is because the owner of the vehicle in violation may become aware of the violation immediately. In the event the owner has forgotten about the vehicle being parked in a time restricted location, the owner may, as a result of being notified on a mobile device, have an opportunity to mitigate the situation (e.g., by moving the vehicle or authorizing additional payment to extend the parking session) before further penalties are assessed.

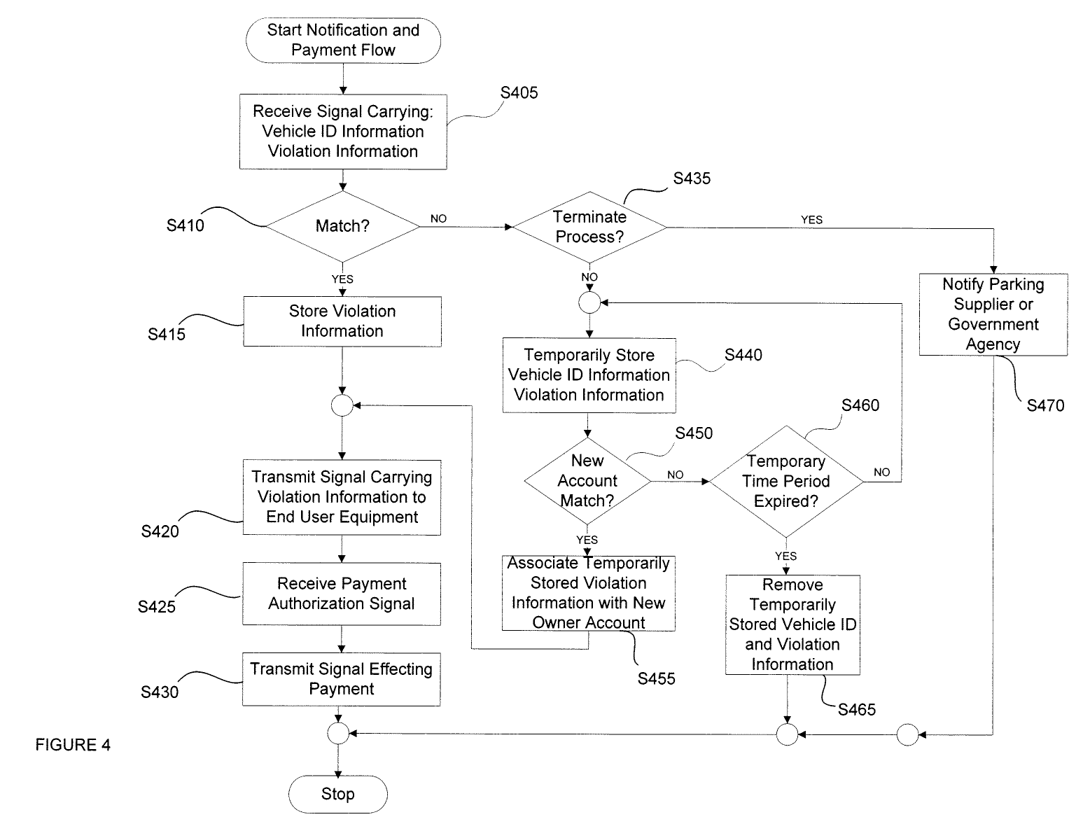

FIG. 4 is a flowchart that further illustrates the notification function described above. Following a vehicle violation, the citation management system 110 will receive a signal carrying the vehicle identification (ID) information and violation information, as shown in step S405. The citation management system 110 then attempts to match the received vehicle ID information with vehicle ID information stored in owner profile data in the aforementioned database, in accordance with decision block S410.

If the citation management system 110 is able to match the vehicle ID information with vehicle ID information stored in the database, in accordance with the YES path out of decision block S410, the citation management system 110 will then store the violation information accordingly, as indicated in step S415, such that the violation is associated with the corresponding owner account. The citation management system 110 will then notify the owner by transmitting a signal to end user equipment specified in the owner's profile data, as shown by step S420. The notification will hopefully prompt the owner to select the appropriate option displayed on the end user equipment to effect payment of the fine. This is described in more detail below. In general, however, a payment authorization signal will be sent to and received by the citation management system 110, as shown by step S425, if and when the owner selects the appropriate option to effect payment. The citation management system 110 will, in turn, transmit a signal effecting payment, as shown by step S430.

If the citation management system 110 cannot match the vehicle ID information with vehicle ID information stored in the database, in accordance with the NO path out of decision block S410, the citation management system 110 may terminate the process as indicated by the YES path out of decision block S435, as the vehicle involved with the violation is not associated with an established owner account. Additionally, as shown in step S470, the citation management system 110 may send a signal back to the entity that transmitted the signal carrying the vehicle ID information and the violation information (e.g., a parking supplier or government agency), informing the entity that the citation management system 110 currently maintains no existing owner account that includes the identified vehicle, thereby leaving it to the entity to notify the owner of the vehicle that a violation has occurred and that the owner must pay a fine in accordance with conventional methods.

Alternatively, and as FIG. 4 further illustrates, the citation management system 110 may temporarily store the vehicle ID and violation information provided in the received signal, as shown in step S440, if the citation management system 110 determines that the vehicle ID information in the received signal does not match any vehicle ID information currently stored in the database, in accordance with the NO path out of decision step S410. The citation management system 110 may temporarily store the vehicle ID and violation information for a predetermined period of time, during which, the citation management system 110 may continuously determine whether any newly established owner account includes vehicle ID information that matches the temporarily stored vehicle ID information, as shown by decision step S450. If, during the predetermined period of time, the citation management system 110 determines that a newly established owner account does include vehicle ID information that matches the temporarily stored vehicle ID information, in accordance with the YES path out of decision step S450, the citation management system 110 will associate the corresponding, temporarily stored violation information with the newly established owner account, as shown in step S455. If, however, during the predetermined period of time, the citation management system 110 determines that no owner account has been established that includes the vehicle ID information that is temporarily stored, in accordance with the NO path out of decision step S450, the citation management system 110 may determine if the predetermined period of time has expired, in accordance with decision step S460. If the citation management system 110 determines that the predetermined period of time has expired, pursuant to the YES path out of decision step S460, the citation management system 110 may remove the temporarily stored vehicle ID and violation information (e.g., by deleting the information from memory or by permitting the information in memory to be overwritten), as shown in step S465. On the other hand, if the citation management system 110 determines that the predetermined period of time has not expired, pursuant to the NO path out of decision step S460, the citation management system 110 will continue to check whether any newly established owner account contains vehicle ID information that matches the temporarily stored vehicle ID information, as shown by steps S440 and S450.

The notification function would also permit the citation management system 110 to alert or remind the owner that he or she has outstanding, unpaid citations. For example, the citation management system 110 may, based on a predefined period of time, automatically notify the owner that there are unpaid citations that need to be satisfied. Alternatively, or in addition, an event may trigger the citation management system 110 to send a notification to the owner. For example, a triggering event may occur if someone attempts to park a vehicle registered to the owner's profile at a parking facility owned or operated by an entity or agency to which the owner owes one or more fines. In another example, it may be the practice of the entity or agency to periodically send the citation management system 110 a reminder that an owner has one or more unpaid violations. Thus, the reminder may also serve as a triggering event.

The owner will benefit from this notification because the owner will then have the opportunity to immediately satisfy the one or more fines and avoid punitive measures, such as the impounding or booting of the vehicle. The provider of the parking facility will also benefit because the owner is then motivated to satisfy the outstanding citations and be less reluctant to use the parking facility.

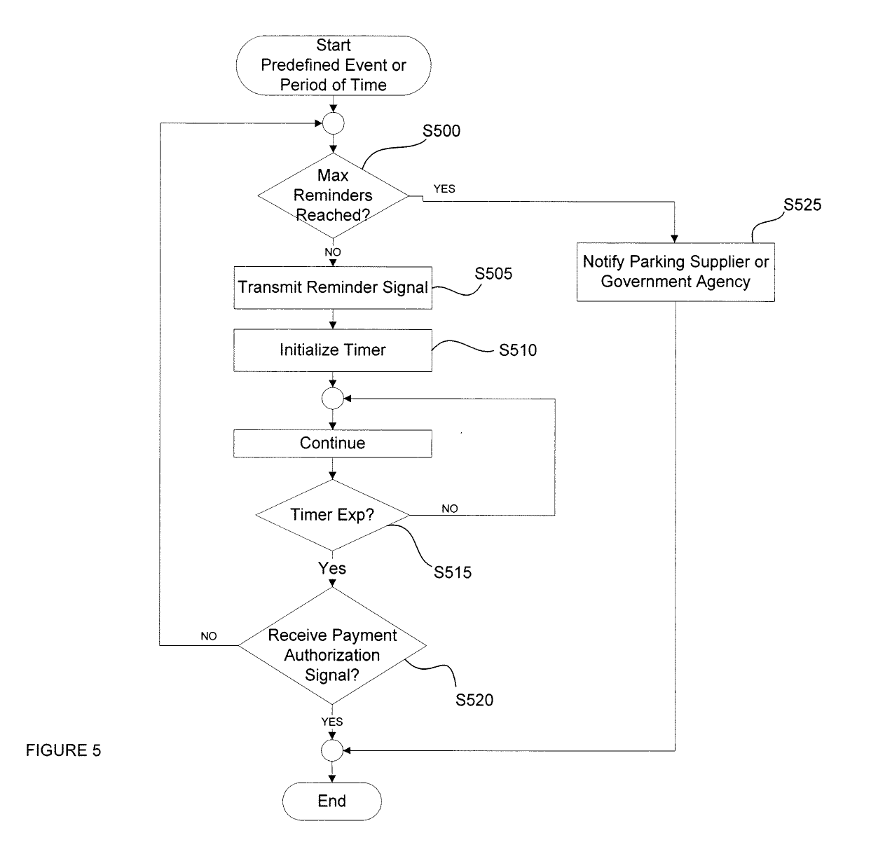

FIG. 5 is a flowchart that further illustrates the notification function with respect to reminding an owner, following a predefined event or period of time, that there remain unpaid violations. In the example illustrated in FIG. 5, the citation management system 110 may be configured such that no more than a maximum number of reminders will be sent to an owner, as shown in decision step S500. If the maximum number of reminders has not been sent, in accordance with the NO path out of decision step S500, the citation management system 110 may, after the occurrence of a predefined period of time or a predefined event, transmit a reminder signal, as shown by step S505, to the end user equipment specified in the corresponding owner's profile data. Simultaneously, or soon thereafter, the citation management system 110 may initiate a timer, as shown by step S510. The timer may be set to any reasonable period of time, for example, 1 week or 1 month. When the timer expires, in accordance with the YES path out of decision block S515, the citation management system 110 would determine whether it has received from the owner a payment authorization signal, as shown by decision step S520. If the citation management system 110 determines that the owner has authorized payment for the aforementioned unpaid violations, in accordance with the YES path out of decision step S520, the citation management system 110 may terminate the reminder process, and effect payment as described below. If, however, the citation management system 110 determines that the owner has not yet authorized payment, in accordance with the NO path out of decision step S520, the citation management system 110 may repeat the process until the maximum number of reminders has been sent or the owner authorizes payment of the aforementioned unpaid violations.

If the owner has not authorized payment for the unpaid violations, and the maximum number of reminders has been sent, in accordance with the YES path out of decision step S500, the citation management system 110 may notify the parking supplier or the government agency that the owner is unresponsive, as shown in step S525. The parking supplier or government agency may reset the maximum number of reminders to allow additional time for the owner to respond and authorize payment, plus any potential late fees. Additional reminder notifications would then be transmitted to the end user equipment, as described above, until the number of reminders again reaches the maximum number. This process may continue to repeat itself, although the parking supplier or government agency may choose at any time to handle the situation through other means, for example, legal means to obtain payment for the unpaid violations.

In accordance with a fourth aspect of the present invention, the citation management system 110, exercising the citation payment function, provides the owner a platform to pay any fines associated with citations for which the citation management system 110 has received information. In support of this function, the citation management system 110 is capable of providing a list of the citations, which is accessible on the citation management system 110 website.

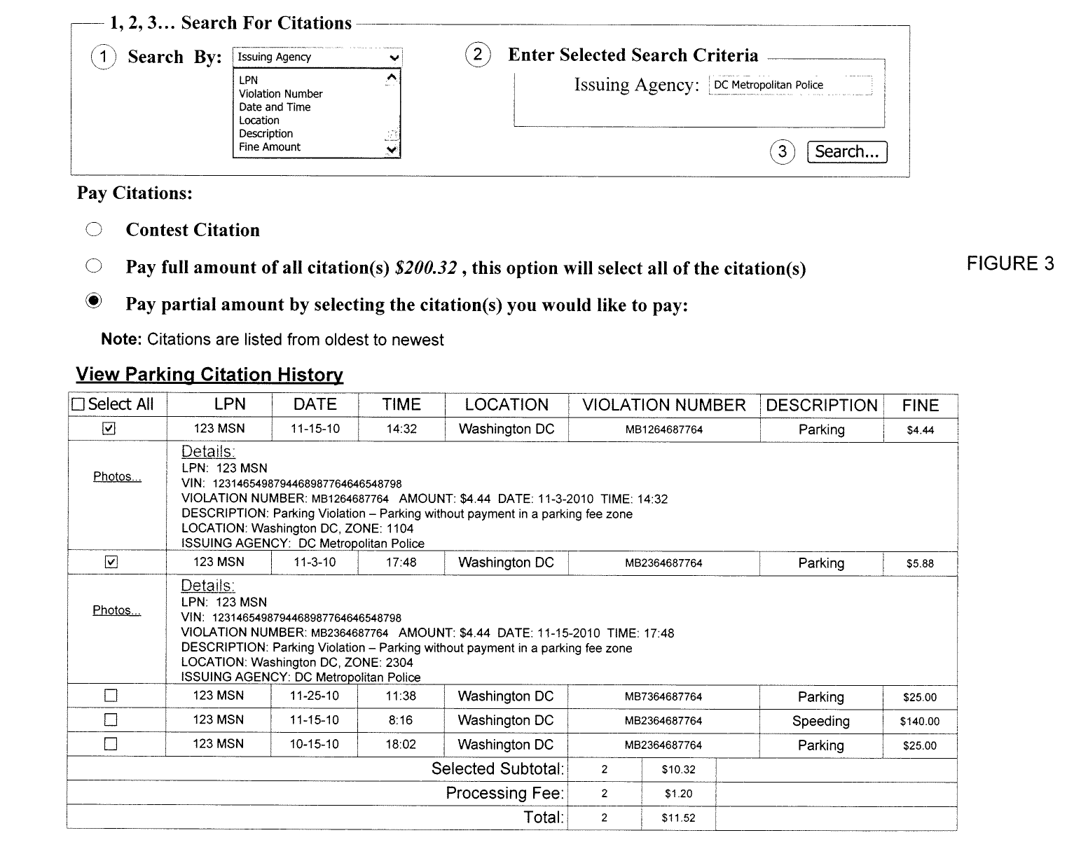

FIG. 3 illustrates one possible display available through the citation management system 110 website listing one or more citations associated with the owner. In this exemplary listing, the citation management system 110 displays, for each citation, the LPN, the date of the violation, the time of the violation, the location of the violation, the violation number (e.g., the parking ticket identification number), a description of the violation (e.g., parking, speeding), and the amount of any fine associated with the violation. In addition, there is an option to expand the information provided for any one or more of the citations. In FIG. 3, detailed information is displayed for two citations, i.e., violation no. MB1264687764 and violation no. MB2364687764. The detailed information includes the vehicle identification number (VIN); photographs, if available; a more detailed description of the violation; and more detailed information as to the location of the violation.

The owner may then utilize the display presented in FIG. 3 to pay one or more of the fines associated with the listed citations. In the exemplary list of FIG. 3, a checkbox is provided for each of the listed citations. To select one or more citations for payment, the owner would check the checkbox associated with the corresponding citations. In FIG. 3, the owner has checked the checkbox associated with the first two citations. The citation management system 110 automatically sums the fines associated with the selected citations and displays a selected subtotal. In this example, the selected subtotal is $10.32. The citation management system 110 also displays the amount of any processing fee(s); in this example, there is a processing fee of $1.20. The citation management system 110 then sums the amount of the selected subtotal and the amount of the processing fee(s) and displays the total payment amount. In this example, the total payment amount is $11.52.

Although, in the example described above, the owner opted to pay two of the fines associated with five of the listed citations, the owner could have opted to pay the fines associated with each and every citation. As shown in FIG. 3, the owner would accomplish this by selecting the option “Pay full amount of all citation(s).” In this example, the amount of all fines is $200.32. If the owner opts to pay the fines associated with each and every citation, the citation management system 110 would display the amount of $200.32 as the selected subtotal, provide the amount of any processing fee(s), sum the two amounts and display the total payment amount.

The citation management system 110 would, thereafter, proceed with the transaction according to the payment preference information stored as part of the owner profile data in the database. Thus, for example, if the owner had set up a stored value account, as described above, The citation management system 110 would proceed by debiting the owner's stored value account and electronically authorizing payment to the entity or agency that issued each of the selected citations.

FIG. 3 also shows that the owner has the option of contesting a citation. If the owner believes that a citation was issued in error, the owner may, for example, select the suspect citation on the citation history display. If the owner chooses this option, the citation management system 110 may present the owner with a secondary display (not shown) that permits the owner to identify and/or attach evidence that the citation was issued in error. For instance, the owner may identify and/or attach a completed payment transaction receipt, as mentioned above, evidencing that no citation should have been issued for the parking session in question. The receipt may take the form of payment evidence pulled from a cashless parking system, or a snapshot of a printed receipt taken either with a mobile device or scanned-in with a scanner. The citation management system 110 would then transmit the evidence to the citation issuing agency, and if the citation issuing agency determines that the citation was issued in error, the citation issuing agency will notify the citation management system 110 and the citation management system 110 will, in turn, update the owner's citation history by indicating that the citation was reversed and, using the owner notification function described above, the citation management system 110 will then notify the owner that the citation issuing agency did, in fact, reverse the citation.

Further, in accordance with the exemplary citation listing illustrated in FIG. 3, The owner has the ability to select an option that will display a citation history (not shown) associated with his or her account. It will be apparent to one skilled in the art that the citation history might include a listing of citations similar to the listing in FIG. 3, but for the listing might include both paid and unpaid citations. The list may include all citations associated with the owner dating back to the establishment of the owner's account, or the list may be limited to a more shortened time period.

It will be apparent that the citation management system 110 may provide the owner with the ability to display the list of citations in any one of a number of ways, whether it be a list of unpaid citations, as shown in FIG. 3, or a complete citation history. For example, the owner may have the option of displaying the citation list by chronology, by vehicle, by violation type, by location, by violation number or by the citation issuing entity or agency. One skilled in the art will, however, appreciate that other sorting options are possible.

As FIG. 3 further illustrates, the citation management system may allow the owner to search the stored citation history information and display citations that satisfy the search criteria. Thus, for example, the owner may first \hat{1} select the “Search by” field, such as the Issuing Agency field (i.e., the name of the agency that issued the citation), the LPN field or the Violation Number field, as shown. This may be implemented with a pull-down menu on the display. In the example of FIG. 3, the owner selected the “Issuing Agency” field. The owner would then \hat{2} enter the search criteria. In this example, the owner selected “DC Metropolitan Police.” The owner would then initiate the search \hat{3} by selecting the Search button on the display. The citation management system 110 will then search and identify all citations in the citation history where the corresponding Issuing Agency field contains text that satisfies the search criteria. It should be noted that the owner could have entered in “DC,” “District of Columbia” or “DC Police” as the search criteria, and the citation management system 110 would have identified all citations in the citation history where the corresponding Issuing Agency field contains text similar to the search criteria or text that exactly matches the search criteria. This search capability may be of significant use to corporate owners, particularly if the corporate owner has hundreds if not thousands of vehicles deployed across the nation or worldwide, and it must keep track of potentially hundreds of, or more, issued citations.

While the present invention has thus far been described, generally, in terms of parking violations, and managing citations associated with parking violations, the scope of the invention should not be limited thereto. For example, in much the same way that parking supplier equipment 130 captures vehicle information in response to a parking violation, a traffic camera and speed sensor 132, or like device, may capture vehicle information as a result of a moving violation, such as a speeding violation or failing to obey a traffic sign or signal such as a stop sign or a RED light. As in the case of a parking supplier device 130, the traffic camera and speed sensor 132, or like device, may transmit a signal to the citation management system 110, wherein the signal contains information relating to the moving violation and vehicle identification. The signal may be transmitted directly to the citation management system 110 or indirectly through another system, such as a local, state or federal agency system 140 (e.g., a system associated with a state Department of Motor Vehicles or DMV), as illustrated in FIG. 2B. In fact, the illustrative example of FIG. 3, described above, includes at least one citation associated with speeding.

The scope of the present invention should not be interpreted such that the citation management system 110 only communicates with one or more parking supplier devices 130 and/or one or more local, state or federal agency devices 140 within a given geographic range. To the contrary, the citation management system 110, according to exemplary embodiments of the present invention, will be capable of receiving, capturing, storing and managing citation information for a vehicle owner regardless of the geographic location of the violation. Thus, the citation management system 110 will be capable of receiving, capturing, storing and managing citations relating to violations that occur locally, nationally or even internationally.

The scope of the present invention also should not be interpreted such that citation information is received at the citation management system 110 passively. As described above, devices such as the parking supplier device 130 will send a signal to the citation management system 110, thus alerting the citation management system 110 to the violation. Alternatively, or in addition to, the citation management system 110 may actively query devices, such as a parking supplier devices 130 or local, state and federal agency devices 140 to determine if any of the citation management system account owners have citations stored and/or recorded therein. The citation management system 110 may then handshake with such devices to effect the transfer of citation and vehicle information so the citation management system 110 can capture, store and manage the information as described above.

The present invention has been described above in terms of a preferred embodiment and one or more alternative embodiments. Moreover, various aspects of the present invention have been described. One of ordinary skill in the art should not interpret the various aspects or embodiments as limiting in any way, but as exemplary. Clearly, other embodiments are well within the scope of the present invention. The scope the present invention will instead be determined by the appended claims.

I claim:

1. A vehicle citation management method comprising:
receiving a signal associated with a citation, the signal carrying identification information corresponding to a vehicle that was involved with a violation and carrying citation information relating to the violation;
determining whether the vehicle identification information in the received signal matches vehicle identification information stored in memory; and
if it is determined that the vehicle identification information in the received signal matches vehicle identification information stored in memory, transmitting a signal to end user equipment based on contact information stored in memory, wherein the contact information corresponds to the matching vehicle identification information stored in memory, and wherein the transmitted signal is carrying the citation information.

2. The method of claim 1 further comprising:
storing the citation information in memory, if it is determined that the vehicle identification information in the received signal matches vehicle information stored in memory.

3. The method of claim 2 further comprising:
receiving a signal from end user equipment authorizing the payment of a fine associated with the citation; and
transmitting one or more signals effecting the payment of the fine.

4. The method of claim 3 further comprising:
storing payment information in memory indicating that the fine associated with the citation has been paid.

5. The method of claim 2 further comprising:
receiving a signal from end user equipment contesting the citation.

6. The method of claim 5 further comprising:
transmitting a signal to the citation issuing agency, the transmitted signal carrying evidence to support the contesting of the citation;
receiving a signal from the citation issuing agency, the received signal carrying a decision associated with the contesting of the citation;
transmitting a notification signal to end user equipment, the transmitting notification signal carrying information regarding the decision.

7. The method of claim 6 further comprising:
updating the citation information stored in memory in accordance with the decision.

8. The method of claim 2, wherein the citation information includes information that identifies a fine associated with the violation, the method further comprising:
periodically transmitting a signal to the end user equipment, based on the contact information stored in memory, the transmitted signal carrying a notification indicating that the fine has not been paid.

9. The method of claim 2, wherein the citation information includes information that identifies a fine associated with the violation, the method further comprising:
transmitting a signal to the end user equipment, based on the contact information stored in memory and in response to a predefined event, the transmitted signal carrying a notification indicating that the fine has not been paid.

10. The method of claim 9, wherein the violation is a parking violation and wherein the predefined event is the parking of the vehicle in the same parking facility where the violation occurred, or a parking facility related thereto.

11. The method of claim 9, wherein the violation is a parking violation and wherein the predefined event is the parking of the vehicle in the same jurisdiction where the violation occurred.

12. The method of claim 1, wherein the violation is a vehicle parking violation.

13. The method of claim 1, wherein the violation is a moving vehicle violation.

14. The method of claim 1, wherein the vehicle identification information in the received signal is vehicle license plate information.

15. The method of claim 1, wherein transmitting the signal to the end user equipment comprises:
transmitting an email message.

16. The method of claim 1, wherein transmitting the signal to the end user equipment comprises:
transmitting a voice mail message.

17. The method of claim 1, wherein transmitting the signal to the end user equipment comprises:
transmitting a multimedia message.

18. The method of claim 1, wherein transmitting the signal to the end user equipment comprises:
transmitting the signal to a mobile device.

19. The method of claim 18, wherein transmitting the signal to the end user equipment comprises:
transmitting a text message.

20. The method of claim 18, wherein transmitting the signal to the end user equipment comprises:
transmitting the signal, at least in part, via a cellular network.

21. The method of claim 1, wherein the received signal is received via the Internet.

22. The method of claim 1, wherein the transmitted signal is transmitted, at least partially, via the Internet.

23. The method of claim 2 further comprising:
for a given owner, storing information in memory corresponding to one or more citations.

24. The method of claim 23 further comprising:
searching the information stored in memory corresponding to the one or more citations;
identifying select citations that satisfy search criteria.

25. The method of claim 24 further comprising:
Transmitting a signal to the end user equipment, the transmitted signal carrying information that permits the select citations to be displayed on the end user equipment.

26. The method of claim 25, wherein the search criteria includes citation issuing agency name.

27. A method for managing violations associated with a vehicle, the method comprising:
receiving a signal carrying identification information corresponding to a vehicle that was involved with a violation, and carrying information relating to the violation;
determining whether the vehicle identification information in the received signal matches vehicle identification information stored in memory; and
if it is determined that the vehicle identification information in the received signal matches vehicle identification information stored in memory, transmitting a signal to end user equipment based on contact information stored in memory, wherein the contact information corresponds to the matching vehicle identification information stored in memory, and wherein the transmitted signal is carrying information relating to the violation.

28. The method of claim 27 further comprising:
receiving a signal from the end user equipment authorizing the payment of any amount due as a result of the violation; and
transmitting one or more signals effecting the payment.

29. The method of claim 27, wherein the vehicle identification information in the received signal is vehicle license plate information.

30. The method of claim 27, wherein the end user equipment is a mobile device.

31. The method of claim 27, wherein the information relating to the violation includes information that identifies a fine associated with the violation, the method further comprising:
periodically transmitting a signal to the end user equipment, based on the contact information stored in memory, the transmitted signal carrying a notification indicating that the fine has not been paid.

32. The method of claim 27, wherein the information relating to the violation includes information that identifies a fine associated with the violation, the method further comprising:
transmitting a signal to the end user equipment, based on the contact information stored in memory and in response to a predefined event, the transmitted signal carrying a notification indicating that the fine has not been paid.

33. The method of claim 32, wherein the violation is a parking violation and wherein the predefined event is the parking of the vehicle in the same parking facility where the violation occurred, or a parking facility related thereto.

34. The method of claim 32, wherein the violation is a parking violation and wherein the predefined event is the parking of the vehicle in the same jurisdiction where the violation occurred.

35. A vehicle citation management method comprising:
receiving a signal from each of a plurality of network devices, each signal carrying identification information for a vehicle that was involved with a plurality of violations and carrying citation information relating to each of the plurality of violations;
for each of the received signals, determining whether the vehicle identification information in the corresponding, received signal matches vehicle identification information stored in memory and, if it is determined that the vehicle identification information in the corresponding, received signal matches vehicle identification information stored in memory, transmitting a signal to end user equipment based on contact information stored in memory, wherein the contact information corresponds to the matching vehicle identification information stored in memory, and wherein the transmitted signal is carrying the citation information in the corresponding, received signal.

36. The method of claim 35 further comprising:
for each of the plurality of received signals, storing the citation information in memory, if it is determined that the vehicle identification information in the corresponding, received signal matches vehicle information stored in memory.

37. The method of claim 36, wherein storing the citation information in memory comprises:
storing the citation information in a memory location associated with an owner of the vehicle involved in the violation corresponding to the citation.

38. The method of claim 37, wherein the vehicle identification information in each of the plurality of received signals is associated with the same owner.

39. The method of claim 38, wherein the vehicle identification information in each of the plurality of received signals is associated with the same vehicle.

40. The method of claim 38 further comprising:
transmitting one or more signals to enable the end user equipment to display a list comprising citation information stored in memory for one or more citations associated with the same owner.

41. The method of claim 40 further comprising:
receiving a signal from the end user equipment contesting one of the one or more citations.

42. The method of claim 41 further comprising:
transmitting a signal to an agency associated with the issuing of the one citation, the transmitted signal carrying evidence to support the contest;
receiving a signal from the agency, the received signal carrying a decision associated with the contest;
transmitting a notification signal to end user equipment, the transmitted notification signal carrying information regarding the decision.

43. The method of claim 42 further comprising:
updating the citation information stored in memory in accordance with the decision.

44. The method of claim 40, wherein the citation information for the one or more citations includes citation identification information; date/time of violation, a description of the violation, fine amount and citation issuing agency name.

45. The method of claim 44 further comprising:
storing information in memory corresponding to one or more citations for a given owner.

46. The method of claim 45 further comprising:
searching the information stored in memory corresponding to the one or more citations;
identifying one or more select citations that satisfy search criteria.

47. The method of claim 46 further comprising:
transmitting a signal to the end user equipment, the transmitted signal carrying information that permits the one or more select citations to be displayed on the end user equipment.

48. The method of claim 47, wherein the search criteria includes citation issuing agency name.

49. The method of claim 44, wherein the citation information for the one or more citations further includes an indication as to whether the fine associated with a corresponding citation has been paid.

50. The method of claim 40 further comprising:
receiving one or more citation selection signals from the end user equipment, wherein each of the received one or more citation selection signals indicates a selection of a corresponding one of the one or more citations associated with the same user; and
transmitting one or more citation payment signals effecting the payment of the fine associated with each of the selected citations.

51. The method of claim 50, wherein the payment of the fine associated with each of the selected citations involves a single transaction.

52. The method of claim 50 further comprising:
storing payment information in memory indicating that the fine associated with each of the selected citations has been paid.

53. The method of claim 35, wherein the violation is a vehicle parking violation.

54. The method of claim 35, wherein the violation is a moving vehicle violation.

55. The method of claim 35, wherein the vehicle identification information in the received signal is vehicle license plate information.

56. The method of claim 35, wherein each of the network devices is associated with a different jurisdiction.

57. The method of claim 35 further comprising:
transmitting a citation information request signal to each of a plurality of network devices, wherein the plurality of received signals are received in response to the transmission of the citation information request signal.
